(19) United States
(12) Patent Application Publication
(10) Pub. No.: US 2016/0173563 A1
(43) Pub. Date: Jun. 16, 2016

(54) Rotation Control of an External Display Device

(71) Applicant: Microsoft Technology Licensing, LLC, Redmond, WA (US)

(72) Inventors: Elizabeth F. Threlkeld, Redmond, WA (US); Ryan Chandler Pendlay, Bellevue, WA (US); Mohammed Kaleemur Rahman, Seattle, WA (US)

(21) Appl. No.: 14/568,671

(22) Filed: Dec. 12, 2014

(51) Int. Cl. H04L 29/08; G06F 3/0484; G06F 3/0488

(52) U.S. Cl. CPC H04L 67/025; G06F 3/04883; G06F 3/0484

(57) ABSTRACT

Rotation control techniques of an external display device are described. In one or more implementations, an input is received at a mobile communications device to cause rotation of a display of a user interface that is generated and output by the mobile communications device and displayed by an external display device that is communicatively coupled to the mobile communications device. Responsive to the input, the display of the user interface generated by the mobile communications device is rotated and the external display device is controlled to display the rotated display of the user interface.

### BACKGROUND

Users have access to a devices having a variety of different form factors that are optimized for different uses. For example, a mobile communications device, such as a mobile phone or tablet, may include a housing that is configured to be held by one or more hands of a user. As the mobile communications device is configured to be mobile, however, an available display area of the display device may be limited to promote this mobility.

Techniques have been developed to expand functionality available via the mobile computing device. An example of this includes use of portrait and landscape views of the mobile communications device, which may be used to provide different functionality. For a calculator application, for instance, a user interface of the application includes basic calculator functions with large keys in the portrait configuration and advanced functionality such as Sine and Cosine functions in a landscape configuration. When connecting to an external display device such as a television, however, conventional techniques limited the display of the user interface to a single configuration and thus users could not avail themselves of functionality available in other configurations.

### SUMMARY

Rotation control techniques of an external display device are described. In one or more implementations, an input is received at a mobile communications device to cause rotation of a display of a user interface that is generated and output by the mobile communications device and displayed by an external display device that is communicatively coupled to the mobile communications device. Responsive to the input, the display of the user interface generated by the mobile communications device is rotated and the external display device is controlled to display the rotated display of the user interface.

In one or more implementations, display is caused of a user interface by an external display device by a mobile communications device that generated the user interface through execution of an application. The display of the user interface is performed according to either a landscape or portrait view that involves different arrangements of one or more visual graphical interface features, one or another. Responsive to receipt of an input to rotate the display of the user interface, the user interface is generated in the other of the landscape or portrait view by the mobile communications device and the external display device is controlled to display the generated user interface as controlled by the mobile communications device.

In one or more implementations, a mobile communications device includes a processing system, a wireless communication device configured to form a wireless communicative coupling with an external display device, and memory configured to maintain instructions that are executable by the processing system to implement an operating system and one or more applications that are executable by the processing system to generate a user interface that is communicated wirelessly for display by the external display device. The operating system is configured to expose an application programming interface to the one or more applications to control rotation of the user interface and display of the rotated user interface by the external display device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to perform rotation control techniques.

FIG. 2 depicts a system in an example implementation showing a casting module of FIG. 1 as supporting a plurality of views for display of a user interface of the applications that are controllable via the rotation control module.

FIG. 3 depicts an example implementation in which inputs received via interaction with a mobile communications device are used to control rotation of a user interface displayed by the external display device of FIG. 1.

FIG. 4 depicts an example implementation in which inputs received via interaction with an external display device are used to control rotation of a user interface generated by the mobile communications device and output by the external display device of FIG. 1.

FIG. 5 is a flow diagram depicting a procedure in an example implementation in which rotation of a display of a user interface generated by a mobile communications device and displayed by an external display device is shown.

FIG. 6 is a flow diagram depicting a procedure in an example implementation in which control of display of landscape and portrait views of a user interface by an external display device is controlled by a mobile communications device.

FIG. 7 illustrates an example system including various components of an example device that can be implemented as any type of computing device as described with reference to FIGS. 1-6 to implement embodiments of the techniques described herein.

### DETAILED DESCRIPTION

Overview

Applications configured for use by mobile communications devices in some instances support both portrait and landscape views. Further, different functionality may be exposed in the different views for access by a user to take advantage of a corresponding orientation of an integral display device of the mobile communications device, such as for a tablet or mobile phone. To access these different views at the mobile communications device, a user in conventional techniques physically rotates a housing of the mobile communications device as a whole to control which view is displayed.

In order avail themselves of additional display area of an external display device, the user may cause the mobile communications device to cast the user interface for display by the external display device, e.g., a television or other display device that is not physically secured to the mobile communications device. However, conventional techniques to control configuration of the user interface, i.e., which view is to be used for display on the external display device, are limited to a single view as physical rotation of the mobile communications device could lead to false positives in conventional techniques, which hindered a user's experience with the devices.

Accordingly, techniques are described herein in which a user controls rotation of a user interface that is generated by a mobile communications device and displayed by external display device. The application, for instance, is configured to support portrait and landscape views. A control is output by the mobile communications device and/or the external display device that is selectable to control which view is generated by the mobile communications device and caused to be displayed by the external display device. In this way, the user may efficiently select a desired view and corresponding functionality available via that view and switch between the views as desired. Further discussion of these and other examples are described in the following sections and shown in corresponding figures.

In the following discussion, an example environment is first described that employs the rotation control techniques described herein. Example procedures are then described which are performable in the example environment as well as other environments. Consequently, performance of the example procedures is not limited to the example environment and the example environment is not limited to performance of the example procedures.

Example Environment

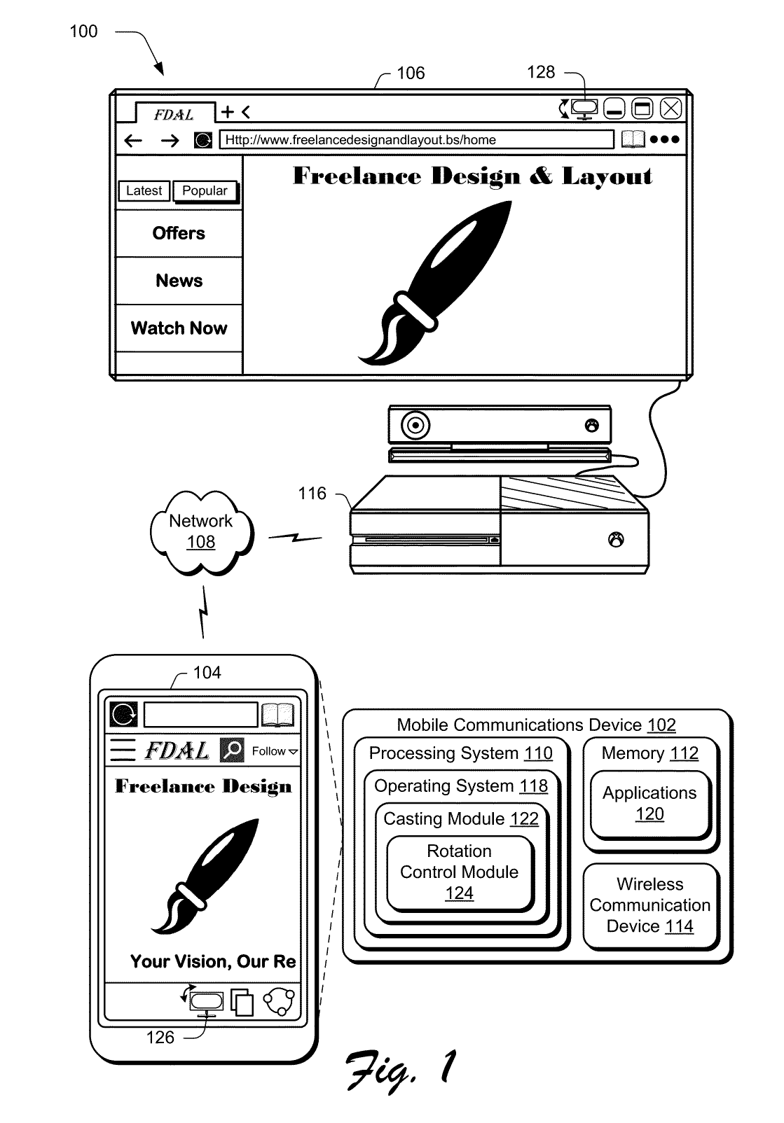

FIG. 1 is an illustration of an environment 100 in an example implementation that is operable to employ the rotation control techniques described herein. The illustrated environment 100 includes a mobile communications device 102 having an integral display device 104 and an external display device 106 that are communicatively coupled, one to another, via a network 108.

The mobile communications device 102 is configurable in a variety of ways. For example, the mobile communications device 102 is configurable as a mobile station, an entertainment appliance, a portable game device, may have a housing configured in accordance with a handheld configuration (e.g., a mobile phone or tablet in a slate or clamshell configuration) and thus configured to be held by one or more hands of a user, and so forth. Thus, the mobile communications device 102 ranges from full resource devices with substantial memory and processor resources (e.g., tablet computers) to low-resource devices with limited memory and/or processing resources (e.g., hand-held game consoles).

The computing device 102 is illustrated as including a processing system 110, an example of a computer-readable storage medium illustrated as memory 112, the integral display device 104 that is secured as an integral part of the housing, and a wireless communication device 114. The processing system 110 is representative of functionality to perform operations through execution of instructions stored in the memory 112. Although illustrated separately, functionality of these components may be further divided, combined (e.g., on an application specific integrated circuit), and so forth.

The wireless communication device 114 is to support a variety of wireless communication techniques. For example, the wireless communication device 114 communicates with the external display device 106 directly or indirectly (e.g., via a game console 116 as illustrated, a set-top box, and so on) via the network 108 using a Wi-Fi connection (e.g., one or more standards in accordance with IEEE 802.11), a Bluetooth® connection, near field communication (NFC), and so forth. Wide area network configurations are also contemplated, such as the Internet. Wired communication techniques are also contemplated to support a communicative coupling between the mobile communications device 102 and the external display device 106.

The mobile communications device 102 is further illustrated as including an operating system 118. The operating system 118 is configured to abstract underlying functionality of the mobile communications device 102 to applications 110 that are executable on the computing device 102. For example, the operating system 118 abstracts processing, memory, network, and/or display functionality of the mobile communications device 102 and thus supports coding of the applications 120 without knowing “how” this underlying functionality is implemented. The application 120, for instance, provides data to the operating system 118 to be rendered and displayed by the integral display device 104 and/or the external display device 106 without understanding how this rendering will be performed. The operating system 118 also represents a variety of other functionality, such as to manage a file system and user interface that is navigable by a user of the mobile communications device 102.

The operating system 118 is illustrated as including a casting module 122. The casting module 122 is representative of functionality to cast a display of a user interface of the applications 120 and/or operating system 118 to the external display device 106 for display by the external display device 106, either directly or indirectly as described above. For example, the casting module 122 casts a user interface generated by the applications 120 via the network 108 wirelessly for display by the external display device 106. In this way, the mobile communications device 102 leverages the casting module 122 to access expanded display functionality available via the external display device 106.

The casting module 122 is also illustrated as including a rotation control module 124, which is representative of functionality to control rotation of a user interface that is to be displayed by the external display device 106. As previously described, applications 120 are configured to support a plurality of views, such as a portrait view as illustrated as displayed by the integral display device 104 and a landscape view as illustrated as displayed by the external computing device 106. The rotation control module 124 includes displays of controls 126, 128 as visual affordances that support user interaction via the integral display device 104 (e.g., via touchscreen functionality) and/or the external display device 106 to control rotation of the user interface, e.g., to switch between the portrait and landscape views and so on.

The functionality represented by the rotation control module 124 may be implemented in a variety of ways. As illustrated, for instance, the rotation control module 124 is included as part of the operating system 118 and includes application programming interfaces that are accessible by the applications 120 to implement the rotation. Thus, in this instance the applications 120 have access to this functionality without knowing how the functionality is implemented, thereby improving efficiency in coding of the applications 120. In another instance, functionality of the rotation control module 124 is incorporated as part applications 120 themselves, implemented as a third-part plugin module, and so forth. This casting is performed in a manner to control functionality of the user interface that is readily available to a user via the different views, thereby increasing efficiency of user interaction, further discussion of which may be found in the following and is shown in a corresponding figure.

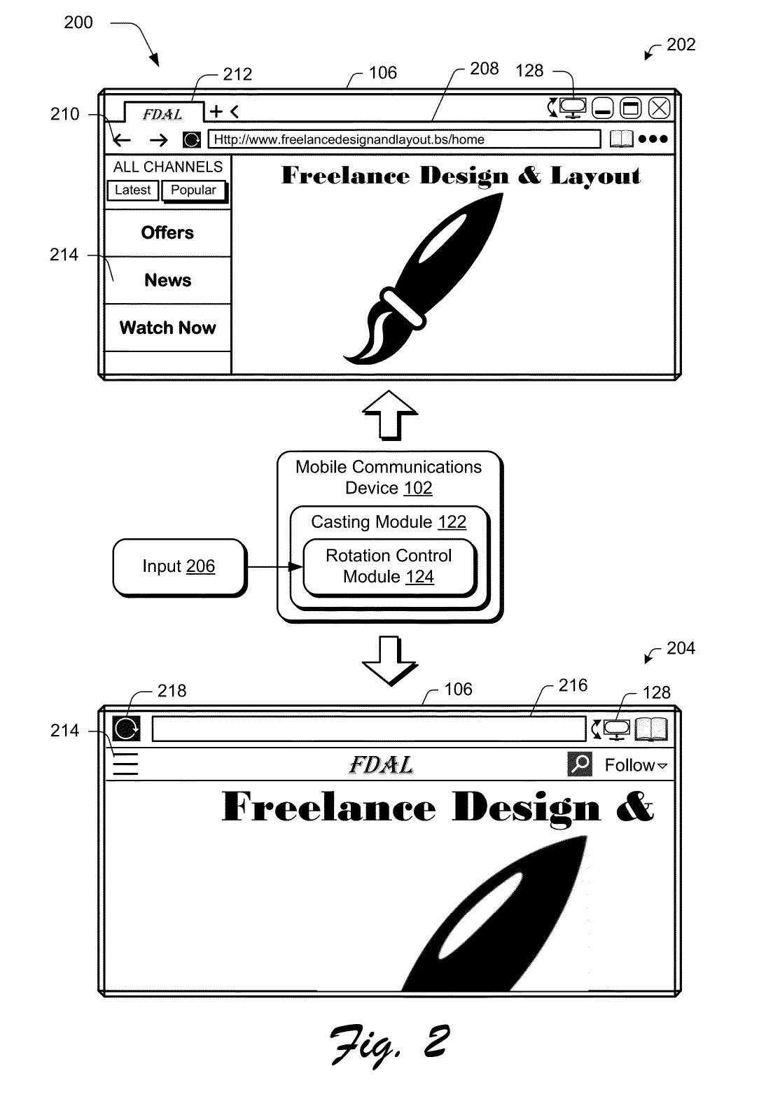

FIG. 2 depicts a system 200 in an example implementation showing a casting module 122 of FIG. 1 as supporting a plurality of views for display of a user interface of the applications 120 that are controllable via the rotation control module 124. The system 200 includes the mobile communications device 102 and the external display device 106 as previously described. A user utilizes the casting module 122 to cause display of a user interface of the applications 120 to be cast from the mobile communications device 102 to the external display device 106 in a landscape view 202 and a portrait view 204 in this example. The application 120 in this instance is a browser but other applications and sources of the user interface are also contemplated, including the operating system 118 itself.

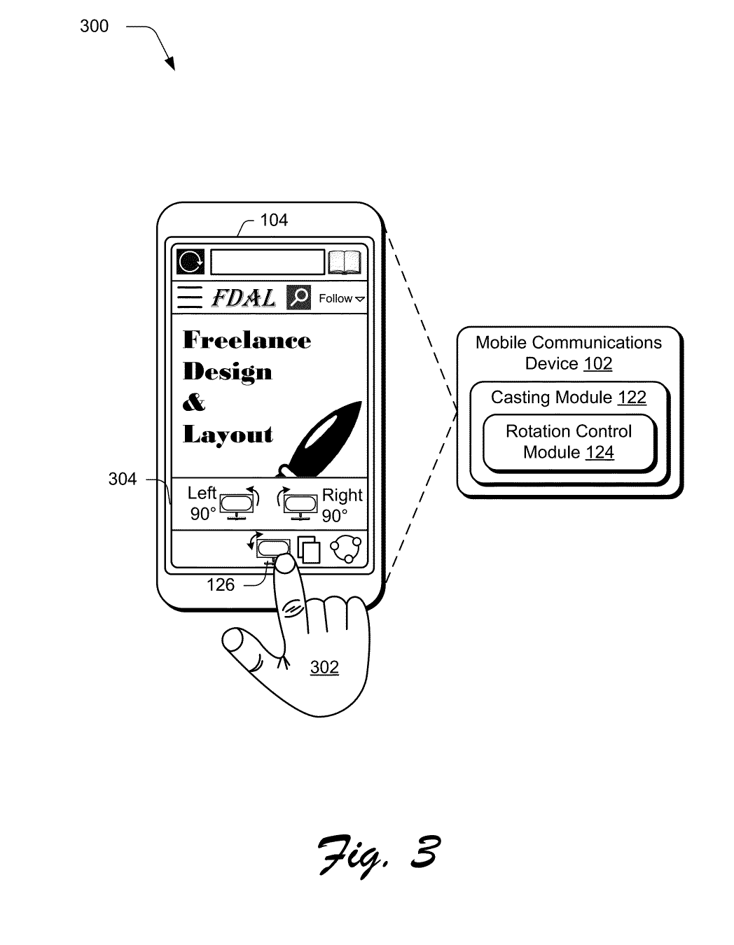

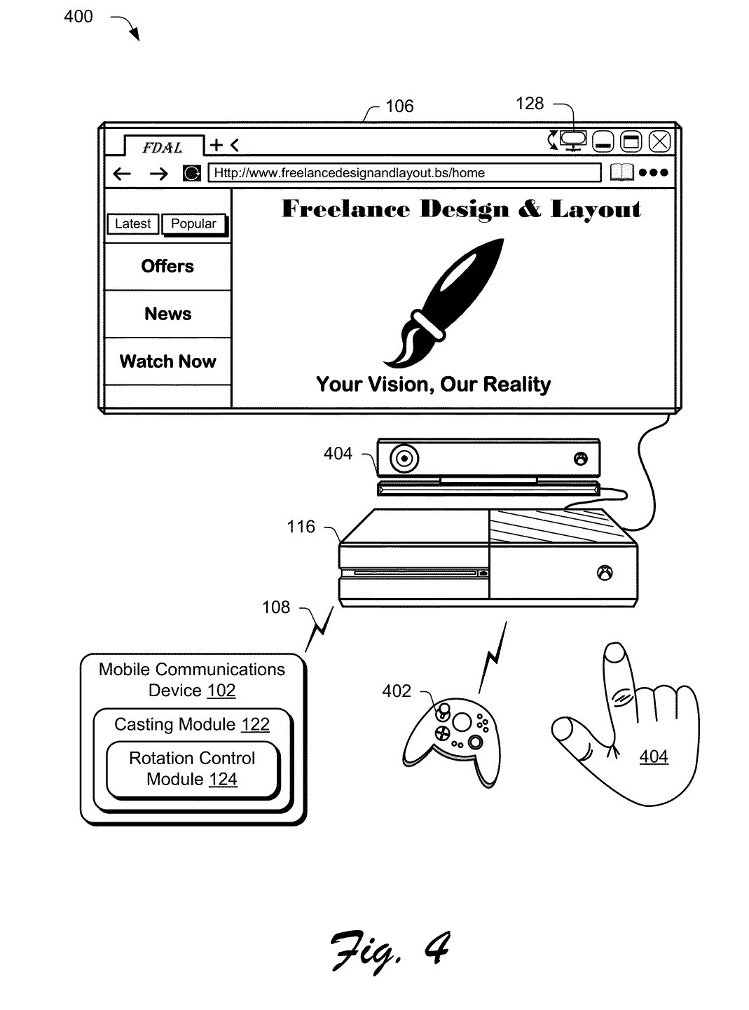

The rotation control module 124 is illustrated as receiving an input 206 to initiate a switch between the displayed portrait and landscape views 202, 204. The input is configurable in a variety of ways, such as through initiation via the control 128 displayed as part of the user interface, a control 126 displayed on an integral display device 104 of the mobile communications device 102, and so on as further described in relation to FIGS. 3 and 4. Responsive to this input, the rotation control module 124 causes generation of the user interface in a corresponding view and causes the external display device 106 to display the generated user interface. This may be performed to access functionality made available via the respective views as desired by a user.

In the landscape view 202, for instance, an available horizontal display area is increased in comparison with the portrait view 204. Thus, additional display elements of the content (e.g., a webpage) in a horizontal direction are viewable that are not available in the portrait view 204. For example, the word “layout” is viewable in the landscape view 202 but not viewable in the portrait view 204.

The landscape view 202 also configures visual graphical interface features of the user interface to leverage an increase in the horizontal display area of the external display device 106. For example, the chrome may include a search bar 208 having a reload option (e.g., illustrated as a circular arrow), a bookmark option (e.g., illustrated as a book), an input option (e.g., illustrated as a box), and so on. The search bar 208 in this case also includes forward and back options 210 for navigation, and supports tabs 212 that are selectable to navigate between content, e.g., webpages that have been downloaded and thus are locally available.

An additional example of visual graphical interface features includes a sidebar 214 that includes options to navigate between content channels of a website. Other visual graphical interface features are also contemplated, such as taskbars, notifications, and so on. In this way, additional functionality of the browser may be made available to the user through interaction with the external display device 106 that is not otherwise available.

In the portrait view 204, a reduced amount of chrome is shown in comparison with the landscape view 202. Examples of chrome include the control 128 as well as a search bar 216, a reload option 218, and so forth. Thus, in this example the user interface output by the external display device mimics but does not match the user interface output by the integral display device 104 of FIG. 1, although other examples are also contemplated in which they do match. The portrait view 204 in this example provides an enlarged view of the content, e.g., the webpage, with minimal chrome in this example. Inputs may also be communicated between the mobile communications device 102 and the external display device 106 to support interaction between the user interfaces, further discussion of which may be found in the following and is shown in a corresponding figure.

FIG. 3 depicts an example implementation 300 in which inputs are received via interaction with the mobile communications device 102 that are used to control rotation of a user interface output by the external display device 106 of FIG. 1. As previously described, a control 126 is output in a user interface displayed by the integral display device 104 that supports user interaction.

Interaction with the control 126 in this example is used to initiate inputs to cause rotation of a user interface generated by an application that is to be output by the external display device 106. The integral display device 104, for instance, is configured to detect the inputs (e.g., recognized as a gesture) using touchscreen functionality, e.g., capacitive sensors, resistive sensors, sensor-in-a-pixel, and so on. In response to detection of proximity of an object, e.g., a finger of a user's hand 302, a menu 304 is output having options that are user selectable to cause rotation ninety degrees to the left or right.

Other examples include “off screen” detection are also contemplated such as a hardware button, detection of a gesture using a camera, and so forth. The interaction, for instance, is usable to switch between portrait and landscape views, to rotate the user interface in 90 degree increments in one or more directions as described above, and so forth. Thus, the inputs are detectable in a variety of ways, such as through touchscreen functionality (e.g., detecting proximity of one or more fingers of a user's hand 302), captured by a camera (e.g., gestures made as part of a natural user interface), voice commands, and so forth. Inputs may also be detected through interaction with the external display device 106, an example of which is described as follows and shown in a corresponding figure.

FIG. 4 depicts an example implementation 400 in which inputs received via interaction with the external display device 106 are used to control rotation of a user interface output by the external display device 106 of FIG. 1. Like the previous example, the external display device 106 is also configurable to detect a variety of different inputs that are initiated to control rotation of the user interface.

The external display device 106, as illustrated in this example, includes a control that is displayed on the external display device 106. The user may then interact with the control as previously described to control rotation, such as to interact with a hardware device such as a game controller 402. In another example, a natural user interface (NUI) device is utilized to detect gestures (e.g., may by one or more hands 406 of a user) that do not involve contact, e.g., through use of depth sensors, a time-of-flight camera, and so forth. Other examples are also contemplated, such as to utilize touchscreen functionality of the external display device 106. Thus, a variety of different inputs are recognizable by the mobile communications device 102 to control rotation of a user interface of the applications 120. Further discussion of these and other examples is described in relation to the following procedures and shown in corresponding figures.

Example Procedures

The following discussion describes rotation control techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the figures described above.

Functionality, features, and concepts described in relation to the examples of FIGS. 1-4 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

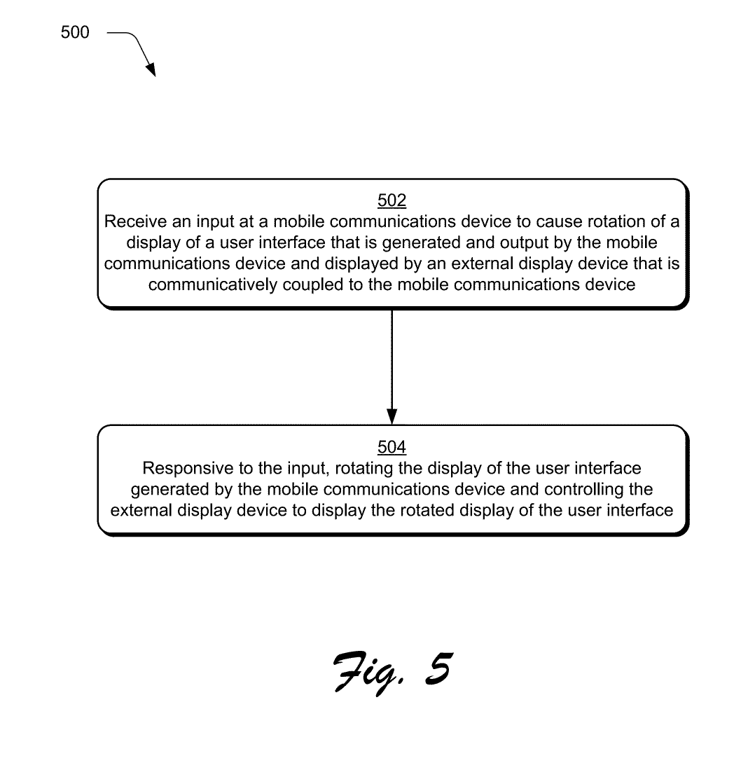

FIG. 5 depicts a procedure 500 in an example implementation in which rotation of a display of a user interface generated by a mobile communications device and displayed by an external display device is shown. An input is received at a mobile communications device to cause rotation of a display of a user interface that is generated and output by the mobile communications device and displayed by an external display device that is communicatively coupled to the mobile communications device (block 502). As previously described, detection of the input is performable by the mobile communications device 104 and the external display device 106,

Responsive to the input, the display of the user interface generated by the mobile communications device is rotated and the external display device is controlled to display the rotated display of the user interface (block 504). The rotation control module 124 of the mobile communications device 102 rotates the user interface and then communications this user interface (e.g., over the network 108) to the external display device 106 for display and thus controls the display of the external display device 106. The rotation is performable in increments (e.g., 90 degrees to the right or left) and is also performable to switch between portrait and landscape views of the user interface supported by the applications 120, an example of which is described in the following and shown in a corresponding figure.

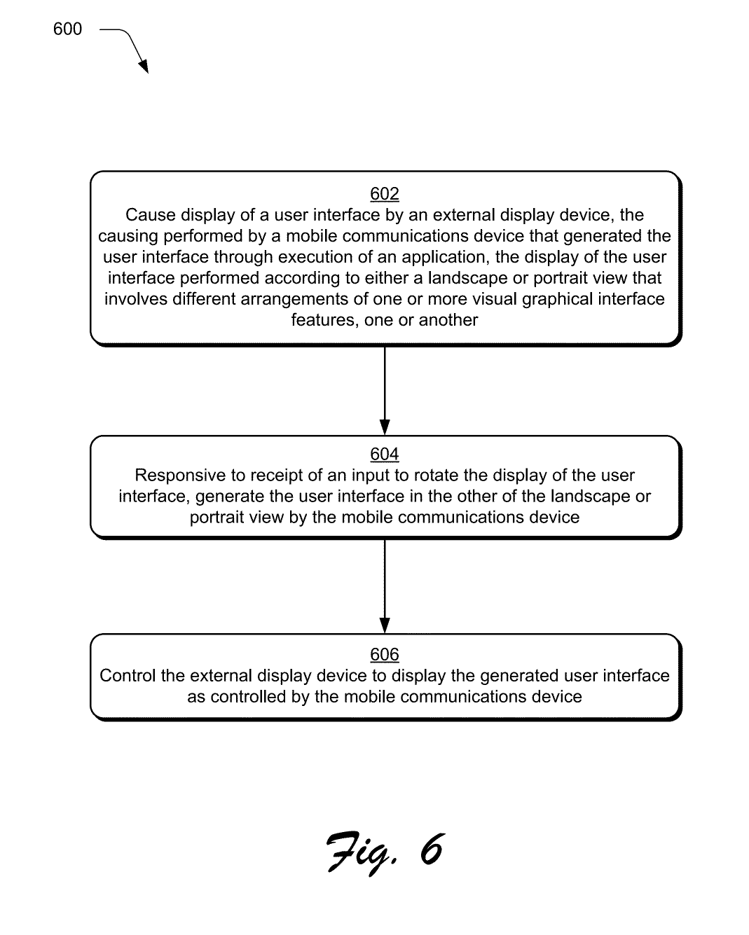

FIG. 6 depicts a procedure 600 in an example implementation in which control of display of landscape and portrait views of a user interface by an external display device is controlled by a mobile communications device. Display is caused of a user interface by an external display device by a mobile communications device that generated the user interface through execution of an application. The display of the user interface is performed according to either a landscape or portrait view that involves different arrangements of one or more visual graphical interface features, one or another (block 602). A calculator application, for instance, in a portrait configuration includes basic keys and in a landscape view includes additional keys, such as Cosine, and so on. As shown in FIG. 1, similar differences in visual graphical interface features are illustrated as involving chrome of a user interface of the application.

Responsive to receipt of an input to rotate the display of the user interface, the user interface is generated in the other of the landscape or portrait view by the mobile communications device (block 604). The applications 120 and/or the rotation control module 124 cause configuration of the user interface to switch from an existing view to a different view, e.g., from portrait to landscape or from landscape to portrait.

The external display device is caused to display the generated user interface as controlled by the mobile communications device (block 606). A communication, for instance, is formed that includes the generated user interface for communicative via the network 108 and display by the external display device 106. As such, the mobile communications device 102 generates and controls the output of the user interface. In another example, such control is further divided, e.g., to receive an input via the mobile communications device 102 and/or the external display device 106 and cause the external display device 106 to perform the rotation. A variety of other examples are also contemplated as described above.

Example System and Device

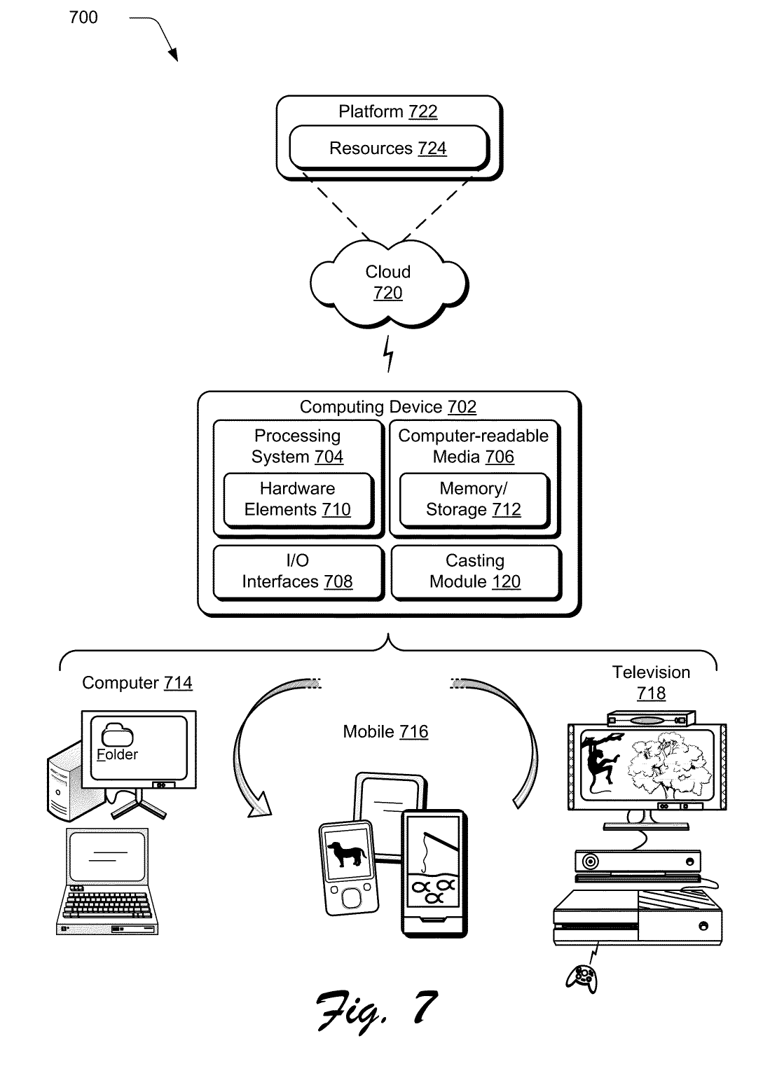

FIG. 7 illustrates an example system generally at 700 that includes an example computing device 702 that is representative of one or more computing systems and/or devices that may implement the various techniques described herein. An example of this is illustrated through inclusion of the casting module 122 which may be utilized to cast a display of an application from one class of computing device to another, the casting module 122 including the rotation module previously described. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This functionality may also be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

### CONCLUSION AND EXAMPLE IMPLEMENTATIONS

Example implementations described herein include, but are not limited to, one or any combinations of one or more of the following examples:

In one or more examples, an input is received at a mobile communications device to cause rotation of a display of a user interface that is generated and output by the mobile communications device and displayed by an external display device that is communicatively coupled to the mobile communications device. Responsive to the input, the display of the user interface generated by the mobile communications device is rotated and the external display device is controlled to display the rotated display of the user interface.

An example as described alone or in combination with any of the other examples described above or below this example, further comprising detecting the input through touchscreen functionality of the mobile communications device involving interaction with a control of the mobile communications device that is displayed by a display device of the mobile communications device.

An example as described alone or in combination with any of the other examples described above or below this example, further comprising detecting the input through touchscreen functionality of the mobile communications device and recognizing a gesture from the input as configured to initiate the rotation.

An example as described alone or in combination with any of the other examples described above or below this example, in which the input is initiated through interaction with a control of the external display device.

An example as described alone or in combination with any of the other examples described above or below this example, in which the input is detected using a camera.

An example as described alone or in combination with any of the other examples described above or below this example, in which the user interface is generated through execution of an application by the mobile communications device.

An example as described alone or in combination with any of the other examples described above or below this example, in which rotating is caused by an operating system that is executed by the mobile communications device and the input is received by the operating system from the application via an application programming interface.

An example as described alone or in combination with any of the other examples described above or below this example, in which the display of the user interface and the rotated display of the user interface include one or more visual graphical interface features that are selectable to initiate operations of the mobile communications device that are different, one to another.

An example as described alone or in combination with any of the other examples described above or below this example, in which the visual graphical interface features are included as part of chrome of the user interface.

An example as described alone or in combination with any of the other examples described above or below this example, in which the external display device is wirelessly communicatively coupled to the mobile communications device.

In one or more examples, display is caused of a user interface by an external display device by a mobile communications device that generated the user interface through execution of an application. The display of the user interface is performed according to either a landscape or portrait view that involves different arrangements of one or more visual graphical interface features, one or another. Responsive to receipt of an input to rotate the display of the user interface, the user interface is generated in the other of the landscape or portrait view by the mobile communications device and the external display device is controlled to display the generated user interface as controlled by the mobile communications device.

An example as described alone or in combination with any of the other examples described above or below this example, in which

An example as described alone or in combination with any of the other examples described above or below this example, in which the external display device is wirelessly communicatively coupled to the mobile communications device.

An example as described alone or in combination with any of the other examples described above or below this example, further comprising detecting the input through touchscreen functionality of the mobile communications device involving interaction with a control or touchscreen functionality of the mobile communications device that is displayed by a display device of the mobile communications device.

An example as described alone or in combination with any of the other examples described above or below this example, in which the input is initiated through interaction with a control of the external display device.

An example as described alone or in combination with any of the other examples described above or below this example, in which the causing is performed through execution of an operating system of the mobile communications device that exposes one or more application programming interfaces that are accessible by the application to initiate the rotation.

An example as described alone or in combination with any of the other examples described above or below this example, in which the one or more visual graphical interface features are displayable as part of chrome of the user interface.

In one or more examples, a mobile communications device includes a processing system, a wireless communication device configured to form a wireless communicative coupling with an external display device, and memory configured to maintain instructions that are executable by the processing system to implement an operating system and one or more applications that are executable by the processing system to generate a user interface that is communicated wirelessly for display by the external display device. The operating system is configured to expose an application programming interface to the one or more applications to control rotation of the user interface and display of the rotated user interface by the external display device.

An example as described alone or in combination with any of the other examples described above or below this example, further comprising an integral display device secured to a housing that is configured to be held by one or more hands of a user, the integral display device configured to

An example as described alone or in combination with any of the other examples described above or below this example, in which the display of the user interface before rotation and the rotated display of the user interface include one or more visual graphical interface features that are selectable to initiate operations of the mobile communications device that are different, one to another.

An example as described alone or in combination with any of the other examples described above or below this example, in which the visual graphical interface features are included as part of chrome of the user interface.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method of controlling rotation of a user interface generated by an mobile communications device that is displayed by an external display device, the method comprising:
receiving an input at the mobile communications device to cause rotation of a display of the user interface that is generated and output by the mobile communications device and displayed by the external display device that is communicatively coupled to the mobile communications device; and
responsive to the input, rotating the display of the user interface generated by the mobile communications device and controlling the external display device to display the rotated display of the user interface.

2. A method as described in claim 1, further comprising detecting the input through touchscreen functionality of the mobile communications device involving interaction with a control of the mobile communications device that is displayed by a display device of the mobile communications device.

3. A method as described in claim 1, further comprising detecting the input through touchscreen functionality of the mobile communications device and recognizing a gesture from the input as configured to initiate the rotation.

4. A method as described in claim 1, wherein the input is initiated through interaction with a control of the external display device.

5. A method as described in claim 1, wherein the input is detected using a camera or a voice input.

6. A method as described in claim 1, wherein the user interface is generated through execution of an application by the mobile communications device.

7. A method as describer in claim 6, wherein rotating is caused by an operating system that is executed by the mobile communications device and the input is received by the operating system from the application via an application programming interface.

8. A method as described in claim 1, wherein the display of the user interface and the rotated display of the user interface include one or more visual graphical interface features that are selectable to initiate operations of the mobile communications device that are different, one to another.

9. A method as described in claim 8, wherein the visual graphical interface features are included as part of chrome of the user interface.

10. A method as described in claim 1, wherein the external display device is wirelessly communicatively coupled to the mobile communications device.

11. A method of controlling rotation of a user interface generated by a mobile communications device that is displayed by an external display device, the method comprising:
causing display of the user interface by the external display device, the causing performed by the mobile communications device that generated the user interface through execution of an application, the display of the user interface performed according to either a landscape or portrait view that involves different arrangements of one or more visual graphical interface features, one or another;
responsive to receipt of an input to rotate the display of the user interface, generating the user interface in the other of the landscape or portrait view by the mobile communications device; and
controlling the external display device to display the generated user interface as controlled by the mobile communications device.

12. A method as described in claim 11, wherein the external display device is wirelessly communicatively coupled to the mobile communications device.

13. A method as described in claim 11, further comprising detecting the input through touchscreen functionality of the mobile communications device involving interaction with a control or touchscreen functionality of the mobile communications device that is displayed by a display device of the mobile communications device.

14. A method as described in claim 11, wherein the input is initiated through interaction with a control of the external display device.

15. A method as described in claim 11, wherein the causing is performed through execution of an operating system of the mobile communications device that exposes one or more application programming interfaces that are accessible by the application to initiate the rotation.

16. A method as described in claim 11, wherein the one or more visual graphical interface features are displayable as part of chrome of the user interface.

17. A mobile communications device comprising:
a processing system;
a wireless communication device configured to form a wireless communicative coupling with an external display device; and
memory configured to maintain instructions that are executable by the processing system to implement an operating system and one or more applications that are executable by the processing system to generate a user interface that is communicated wirelessly for display by the external display device, the operating system is configured to expose an application programming interface to the one or more applications to cause rotation of the user interface and control display of the rotated user interface by the external display device.

18. A mobile communications device as described in claim 17, further comprising an integral display device secured to a housing that is configured to be held by one or more hands of a user.

19. A mobile communications device as described in claim 17, wherein the display of the user interface before rotation and the rotated display of the user interface include one or more visual graphical interface features that are selectable to initiate operations of the mobile communications device that are different, one to another.

20. A mobile communications device as described in claim 19, wherein the visual graphical interface features are included as part of chrome of the user interface.
